(19) United States
(12) Patent Application Publication
(10) Pub. No.: US 2024/0041037 A1
(43) Pub. Date: Feb. 8, 2024

(54) DISINFECTANT AND USE THEREOF

(71) Applicant: Thomas Meneghini, Memmingen (DE)

(72) Inventors: Thomas Meneghini, Memmingen (DE); Marcel Veeger, Goch (DE); Daniel Meneghini, Erkheim (DE)

(73) Assignee: Thomas Meneghini, Memmingen (DE)

(21) Appl. No.: 18/492,432

(22) Filed: Oct. 23, 2023

Related U.S. Application Data
(63) Continuation of application No. PCT/EP2022/060342, filed on Apr. 20, 2022.

(30) Foreign Application Priority Data
Apr. 23, 2021 (DE) 10 2021 002 147.9
May 20, 2021 (DE) 10 2021 002 640.3

(51) Int. Cl. A01N 37/36; A01N 37/10; A01P 1/00; A01N 25/30

(52) U.S. Cl. CPC A01N 37/36; A01N 37/10; A01P 1/00; A01N 25/30

(57) ABSTRACT

The invention relates to a disinfectant including: at least one of citric acid, lactic acid, or succinic acid; at least one of sodium benzoate, potassium benzoate, or calcium benzoate; and one or more nonionic and/or amphoteric surfactants which is/are soluble or emulsifiable or dispersible in water. The disinfectant is present in an aqueous liquid composition or solid composition and in aqueous liquid composition contains the one or more nonionic surfactants in an amount of 1.1 to 3% by weight and/or contains the one or multiple amphoteric surfactants in an amount of 1.1 to 30% by weight. No other surfactants apart from the nonionic and/or amphoteric surfactants are present and also no C1-C3-(iso)alcohols are present.

### CROSS REFERENCE TO RELATED APPLICATIONS

This is a continuation of International Patent Application No. PCT/EP2022/060342 filed on Apr. 20, 2022, which is incorporated in its entirety herein by reference. International Patent Application No. PCT/EP2022/060342 claims priority to German Patent Application No. 10 2021 002 147.9 filed on Apr. 23, 2021, and also claims priority to German Patent Application No. 10 2021 002 640.3 filed on May 20, 2021, which are both incorporated in their entirety herein by reference.

### BACKGROUND OF THE INVENTION

### 1. Field of the Invention

The present invention relates to a disinfectant and use thereof.

### 2. Description of the Related Art

The world-wide virus pandemic has shown that means for reducing the bacterial load and viral load are of great importance. There is therefore an increasing need for disinfectants that are effective, in particular, as hand disinfectants, food disinfectants and surface disinfectants.

Disinfectants are usually chemical compositions or compounds used for disinfecting surfaces, instruments, food, skin, as well as for sterilizing water. Depending on the main pathogens to be combated, in particular bacteria, viruses, fungi and the like, the disinfectants exhibit bactericidal, virucidal or virus-inactivating and levuricidal (fungicidal) efficacies. A disinfection in this case means a reduction in germs, which is checked in a set test procedure, wherein germs capable of reproducing, i.e., so-called colony-forming units per gram (CFU/g) are studied and a reduction in germs is observed.

Disinfectants have versatile uses: they may be used in clinical settings, for example, in hospitals or in medical practices, in public settings, for example, in swimming pools, or in private settings, for example, in cosmetics or in the household and, for a number of years have been subject to an approval process. The use of individual products may be restricted to particular groups of persons such as particularly qualified persons.

The disadvantage of many strong-acting disinfectants is that they not only destroy germs harmful to health but may also damage the skin or surfaces for which they are used. Thus, strong disinfectants generally contain strong oxidants, which may irritate and damage, for example, the mucous membranes. Weak-acting disinfectants on the other hand do not damage the skin or surfaces to be disinfected but are not sufficiently germicidal. It is therefore invariably of interest to develop disinfectants, which rapidly and also permanently destroy the germs, but which, when used for disinfecting hands, do not adversely affect the skin flora in the long term.

Furthermore, strong disinfectants, in particular, may have a disadvantageous impact on the environment. For example, phenols, which are contained in many disinfectants, have an ecotoxic effect on bodies of water and also destroy species of bacteria that are important for the cleansing effect in bodies of water. Many disinfectants are corrosive, irritate the skin and/or mucous membranes, are flammable or even explosive or, when mixed with other household cleansers, may release poisonous chlorine gas. Toxic and carcinogenic disinfectants are also known, which may also trigger allergies. There is therefore a great deal of interest in skin-tolerant disinfectants, which may be safely used not only for disinfecting surfaces, but also innocuously for disinfecting hands and food and, at the same time, which largely reduce the germ colonization found on the skin of the hands. It is desirable that these disinfectants kill off or deactivate, for example, bacteria, viruses and fungi. This may also prevent a transmission of germs from one person to another.

Numerous disinfectants are known from the prior art. Some of these are singled out here with the details briefly explained.

Thus, for example, disinfectants are known, which contain citric acid for regulating the pH value, as chelating agents or for decalcifying:

DE 37 02 546 A1 describes a disinfectant for the medical field, in particular, for use in medical practices or in hospitals, wherein isothiazoline-3-oxi and/or a derivative or derivatives thereof is/are included as the active ingredient. A weak organic acid such as, for example, acetic acid, citric acid, uric acid, gluconic acid, amino sulfonic acid, isethionic acid or sulfophthalic acid, is added in order to regulate the pH value in the range between approximately pH 4.5 and approximately pH 10.5.

EP 2 677 867 B1 of the company Salveco describes a concentrated biocidic formulation of plant origin, which includes plant-based and renewable compounds, the compounds being fully biologically decomposable. The formulation contains:
between 0.01% and 20% chelating agent, selected from citric acid from lemon juice, sorbic acid from the rowan tree, oxalic acid from the roots or rhizomes of plants, chicory extracts;
between 0.03% and 25% nonionic, glycoside-type, polyglycerine ester-type, or sorbitan ester-type surfactants;
between 0.03% and 25% anionic surfactants, selected from the carboxylate salts of polyethoxylated/propoxylated alkyl and or polyglycoside-type and/or polyglycerine-type polyols, alkali metals or alkaline earth metals, and those that are combined with acidic chemical structures in order to form alky carboxylate-type and/or alkyl sulfate-type surfactants, wherein the anionic surfactants include a carbon chain that includes between 6 and 20 carbon atoms;
between 0.1% and 75% of at least one organic acid, selected from citric acid, lactic acid and succinic acid;
between 0.001% and 8% natural fragrance, selected from ethereal oils, plant-based essences and plant extracts, such as A-mint, N-mint or G-eucalyptus. A benzoate or benzoic acid is not mentioned here, however.

JP-A-2002-253188 further discloses a disinfectant for disinfecting hands and surfaces in the food-processing industry, which contains an organic acid based on citrates and lactates, and alcohol, such as ethanol. These disinfectants have a microbiocidal efficacy.

EP 2 135 507 A1 further describes a disinfectant for disinfecting the hands and the skin which, in each case based on the total disinfectant, includes the following components (a), (b), (c), and (d), but no further disinfecting active ingredients for the microbiocidal disinfection:
(a) 40% to 90% by weight of ethanol, isopropyl alcohol or a mixture thereof;
(b) 0.1% to 2% by weight of lactic acid;
(c) 0.01% to 2% by weight of citric acid; and
(d) 0.001% to 0.1% by weight of a zinc-containing compound, which releases zinc ions in solution. Zinc ions may, however, be disadvantageous for the application to the hands, since they dry out the skin and may leave behind skin crusting that is difficult to remove. Zinc-containing compounds, ethanol as well as isopropyl alcohol are optionally not contained in the disinfectant provided according to the invention.

DE 102 23 934 A1 describes an aqueous-based disinfectant, which
(a) includes at least one alkyl amine ad/or at least one quaternary ammonia compound and
(b) at least one fatty acid RCOOH and/or salt thereof,
   wherein R is a group including at least 7 carbon atoms,
   as well as the use of the disinfectant for inactivating the hepatitis B virus. In addition to these components, the disinfectant optionally includes short-chain organic acids, such as lactic acid, glycolic acid, citric acid, malic acid, succinic acid, tartaric acid, formic acid, ascetic acid, propionic acid or salts thereof in order to adjust the amine formulation to the exemplary pH value of 9.0 to 9.5.

DE 10 2007 045 210 A1 further relates to a mixture for decalcifying, cleansing and/or disinfecting, including, with respect to the total volume of the mixture, at least 25% by weight based on the total volume of the mixture of citric acid, and 0.1-75% by weight based on the total volume of the mixture of an additional mixture including malic acid and/or tartaric acid.

Furthermore, disinfectants that include citric acid are also used against viruses and bacteria:

For example, DE 42 00 066 A1 relates to the use of an aqueous disinfectant optionally present in concentrated form with a content of citric acid as a virucidal, bactericidal and sporicidal active ingredient for inactivating hepatitis B viruses, bacterial spores and Legionella pneumophila in the disinfecting of thermolabile medical instruments and devices and parts thereof, dialysis machines and surfaces. Malic acid and/or lactic acid may optionally also be added.

In addition, WO 96/09761 A1 (EP 0 783 245 B1 of Unilever N.V.) describes a disinfectant, which is suitable for consumption and is therefore optionally used in the production of food products and beverages. The disinfection compound includes:
(a) an anionic surfactant, selected from an alkali salt of a C₁₀-C₁₈-alkyl sulfate and an alkali salt of Di-(C₆-C₁₀-alkyl)sulfosuccinate;
(b) an acid, selected from citric acid, phosphoric acid, sulfuric acid, hydrochloric acid, acetic acid, gluconic acid, lactic acid, propionic acid, malic acid and tartaric acid and
(c) a nonionic surfactant that includes a polyethoxylated sorbitan ester, which is readily soluble in water. Furthermore, benzoic acid or sodium acid may optionally also be added. As opposed to WO 96/097761 A1, the disinfectant provided according to the invention is provided only for external application. The use of benzoic acid/sodium benzoate is merely optional and therefore leads away from the present invention. In addition, an anionic surfactant is also not present in the disinfectant provided according to the invention. The use of alcohols such as isopropanol or ethanol as a solvent, as described in WO 96/097761 A1 is also not desirable in the disinfectant provided according to the invention.

Compositions containing benzoates as a preservative have also become known:

Thus, DE 10 2006 010 809 A1 describes a solubilisate of a preservative for better protecting food products, primarily beverages, against infestation of microorganisms. The anhydrous solubilisate of a preservative includes sorbic acid and/or benzoic acid as well as one or multiple emulsifiers having an HLB value of between 9 and 16, in particular a polysorbate. It is described that only the undissociated acid is intended to develop the bactericidal effect.

The following publications describe antimicrobially-acting compounds, which may contain citric acids and benzoate:

In MEDOFFICE: Med-Cover Lemon Glycerin Swab Stick, 6, Material Safety Data Sheet, Izmir, Türkiye, 2018, a skin care product is provided in the form of a stick or as an aqueous solution. The compound includes, among others, sodium benzoate, citric acid, polysorbate 80, lemon aroma and chlorhexidine digluconate. The compound has an antimicrobial effect, in particular, due to the chlorhexidine digluconate. However, no chlorhexidine digluconate is present in the disinfectant provided according to the invention.

US 2020/0 120 928 A1 discloses wet wipes having a cleansing compound that includes:
a preservative-enhancing agent, including between approximately 0.12% by weight and approximately 1.0% by weight of sorbitan caprylate;
a preservative that includes benzoic acid or a salt thereof; and
a citrate-citric acid buffer system or citric acid;
wherein the cleansing composition includes at least 97.1% by weight of water; the preservative and the preservative-enhancing agent include approximately 0.24% by weight to approximately 1.12% by weight of the cleansing composition; the cleansing composition has a pH value of less than 5; and the preservative to the preservative-enhancing agent in the cleansing composition has a weight ratio of approximately 1:0.5 to approximately 1:5. The cleansing composition may have a further component in the form of a nonionic and amphoteric surfactant. However, no sorbitan caprylate is present in the disinfectant provided according to the present invention.

WO 2018/022 016 A1 further describes a liquid cleansing composition, including:
a cleansing component; and
an antibacterial system, wherein the antibacterial system includes:
an antibacterial agent; and
an antibacterial strengthening agent selected, in particular, from an organic acid such as citric acid, acetic acid, lactic acid, glycolic acid, formic acid, butyric acid, propionic acid, valeric acid, malic acid, oxalic acid, carbonic acid, taurine and combinations thereof; wherein the weight ratio of the antibacterial agent to the antibacterial strengthening agent is greater than or equal to approximately 0.30:1 and less than or equal to 0.65:1. The antibacterial agent is phenoxyethanol which, according to the examples, is considered to be a substantial component for the antimicrobial efficacy. Nonionic surfactants are also described as potential components. Sodium benzoate among many others is mentioned as an exemplary preservative. However, no phenoxyethanol is present in the disinfectant provided according to the present invention.

Furthermore, WO 2020/165 566 A1 relates to an aqueous liquid composition, which acts in a topically antimicrobial manner, wherein the composition includes:
a) 0.001% by weight to 1% by weight of surfactant,
b) at least one carbonic acid or a salt thereof, such as citric acid or malic acid, and wherein the aqueous liquid compositions has a pH value of approximately 4.7 or less. Benzoates, in particular, sodium benzoate, are described as preservatives. The preservative should optionally be present in amounts of up to approximately 1.5% by weight, wherein only up to 0.2% by weight of sodium benzoate is, however, used in the examples.

What is needed in the art is a way to provide an improved disinfectant, which significantly reduces the germ load resulting from bacteria, viruses, fungi and the like, and which is suitable for disinfecting hands, food products and also surfaces. In addition, the disinfectant should be intended to be optionally tolerated by the skin and to contain environmentally-friendly components and no strong oxidants such as chlorine, hydrogen peroxide, or C₁-C₃-(iso)-alcohols. In addition, there should be a fast-acting disinfecting effect with a simultaneously broad range of bactericidal effectiveness.

### SUMMARY OF THE INVENTION

A disinfectant includes: an organic acid selected from the group consisting of citric acid, lactic acid, succinic acid, and mixtures thereof; a benzoate selected from the group consisting of sodium benzoate, potassium benzoate, calcium benzoate, and mixtures thereof; and one or more surfactants selected from the group of nonionic surfactants and amphoteric surfactants which are soluble or emulsifiable or dispersible in water. The disinfectant is present in aqueous liquid composition or solid composition. An aqueous liquid composition of the disinfectant contains the one or more nonionic surfactants in an amount ranging from 1.1 to 3% by weight and/or contains the one or more amphoteric surfactants in an amount ranging from 1.1 to 30% by weight. The solid composition is a concentrate and the aqueous liquid composition is the concentrate in diluted form containing the one or more nonionic surfactants in an amount ranging from 1.1 to 3% by weight and/or the one or more amphoteric surfactants in an amount ranging from 1.1 to 30% by weight. The disinfectant is intended for external use only. The one or more nonionic surfactants are selected from the group consisting of fatty alcohol alkoxylates, alkyl polyglucosides alkyl polyglycosides (APGs), and mixtures thereof. The one or more amphoteric surfactants are selected from the group consisting of amine oxides and when, with one or more nonionic surfactants present, one or more moisture control agents are simultaneously present, the moisture control agents being present in an amount ranging from 0.1 to 5% by weight. No surfactants other than the nonionic and/or amphoteric surfactants are present, no C₁-C₃ (iso) alcohols are present, with C₁-C₃ (iso) alcohols being methanol, ethanol, n-propanol and isopropanol, and the compounds chlorhexidine digluconate, sorbitan caprylate, and phenoxyethanol are not present.

In some embodiments provided according to the invention, a method of using a disinfectant is provided. The method includes disinfecting a surface by contacting the surface with the disinfectant for a contact time. The disinfectant includes: an organic acid selected from the group consisting of citric acid, lactic acid, succinic acid, and mixtures thereof; a benzoate selected from the group consisting of sodium benzoate, potassium benzoate, calcium benzoate, and mixtures thereof; and one or more surfactants selected from the group of nonionic surfactants and amphoteric surfactants which are soluble or emulsifiable or dispersible in water. The disinfectant is present in aqueous liquid composition or solid composition. An aqueous liquid composition of the disinfectant contains the one or more nonionic surfactants in an amount ranging from 1.1 to 3% by weight and/or contains the one or more amphoteric surfactants in an amount ranging from 1.1 to 30% by weight. The solid composition is a concentrate and the aqueous liquid composition is the concentrate in diluted form containing the one or more nonionic surfactants in an amount ranging from 1.1 to 3% by weight and/or the one or more amphoteric surfactants in an amount ranging from 1.1 to 30% by weight. The disinfectant is intended for external use only. The one or more nonionic surfactants are selected from the group consisting of fatty alcohol alkoxylates, alkyl polyglucosides alkyl polyglycosides (APGs), and mixtures thereof. The one or more amphoteric surfactants are selected from the group consisting of amine oxides and when, with one or more nonionic surfactants present, one or more moisture control agents are simultaneously present, the moisture control agents being present in an amount ranging from 0.1 to 5% by weight. No surfactants other than the nonionic and/or amphoteric surfactants are present, no C₁-C₃ (iso) alcohols are present, with C₁-C₃ (iso) alcohols being methanol, ethanol, n-propanol and isopropanol, and the compounds chlorhexidine digluconate, sorbitan caprylate, and phenoxyethanol are not present. A contact time of the disinfectant with the surface of 30 seconds is sufficient to exhibit its complete disinfecting effect

### DETAILED DESCRIPTION OF THE INVENTION

In embodiments provided according to the invention, a disinfectant is provided, including:
an organic acid, selected from the group consisting of citric acid, lactic acid and succinic acid or a mixture thereof;
a benzoate, selected from the group consisting of sodium benzoate, potassium benzoate or calcium benzoate, or mixtures thereof;
one or multiple surfactants, selected from the group consisting of nonionic surfactants and/or amphoteric surfactants, which is/are soluble or emulsifiable or dispersible in water, and the disinfectant is present in an aqueous liquid composition or solid composition, wherein an aqueous liquid composition of the disinfectant contains the one or multiple nonionic surfactants in an amount in the range from 1.1 to 3% by weight and/or contains the one or multiple amphoteric surfactants in an amount in the range from 1.1 to 30% by weight, with the proviso that no other surfactants apart from the nonionic and/or amphoteric surfactants are present, in particular, no anionic surfactants and no cationic surfactants. In addition, no C₁-C₃-(iso)alcohols should be present and the compounds chlorhexidine gluconate, sorbitan caprylate and phenoxyethanol are not included.

C₁-C₃-(iso)alcohols are understood to mean methanol, ethanol, n-propanol and isopropanol.

It was unexpectedly found that a combination of citric acid, lactic acid and/or succinic acid, benzoate(s) and water-soluble or water-dispersible nonionic and/or amphoteric surfactant(s) result in a significantly increased disinfecting effect, which is advantageous in particular, for use in hand disinfectants, food product disinfectants and surface disinfectants. Tests have shown that not only a particular high degree of efficacy of the disinfectant is achieved when this combination is present, but also that the effect occurs in an unexpectedly short period of time. This is of great importance in preventing as quickly as possible the risk of a high bacterial load and potentially also a higher viral load. Thus, reductions of germs to a germ content below the detection limit is achieved within 30 seconds, which may be verified in standard laboratory tests EN 1650/EN13624, EN 1275, EN 1276/EN 13727 and EN 14476 as well as in the practical test according to EN 1500/EN 1499.

The disinfectant may be present in an aqueous liquid composition or as a solid composition, in particular, in the form of a concentrate. For example, the disinfectant may constitute a solution, an emulsion, a lotion, a spray, a gel, a foam or a solid material. The solid material is to be understood in broad terms and encompasses, for example, a powder, a granulate and the like, but also a solid-liquid mixture having a high portion of solid material, for example, more than 60% by weight, more than 70% by weight or more than 75% by weight, i.e., solid-liquid mixtures that are not flowable, such as a paste. A solid composition in the form of a concentrate is optionally used, which is water-soluble or emulsifiable or dispersible in water. The water used is not further limited and may, for example, be distilled water, demineralized water, drinkable water or tap water.

In general, the disinfectant in a solid composition as a concentrate is diluted for the respective application with water in order to obtain an aqueous liquid composition. According to the invention, the one or multiple nonionic surfactants are present in the aqueous liquid composition in an amount from 1.1 to 3% by weight and/or the one or multiple amphoteric surfactants are present in an amount from 1.1 to 30% by weight. These ranges have proven to be advantageous for the efficacy of the disinfectant.

The individual components of the disinfectant provided according to the invention are described in detail below:

An organic acid, selected from citric acid, lactic acid and/or succinic acid is used in the disinfectant provided according to the present invention.

Citric acid, for example, is used as an organic acid in the disinfectant provided according to the invention. Citric acid is a colorless, odorless solid, which is readily soluble in water. It is a tricarbonic acid, which carries a hydroxyl group at position 3 of the carbon structure and thus also represents a hydroxycarboxylic acid and belongs to so-called fruit acids. Citric acid and salts thereof are used, for example, for preserving and as an acidifier or acid regulator of food products. These are frequently also used in lime-dissolving cleansers.

Lactic acid may be used as a further or alternative organic acid in the disinfectant provided according to the invention. Lactic acid is a hydroxycarboxylic acid which is completely mixable with water. It is optically active and, depending on the production, a D- or L-lactic acid or a mixture of both isomers may be present, for example, a racemic mixture (1:1 mixture of both isomers). Lactic acid is used, for example, in cosmetics, in skin creams and in other products for treating acne.

An additional or alternative organic acid to be used, which may be used in the disinfectant provided according to the invention is succinic acid. Succinic acid is an aliphatic dicarbonic acid, which is present in the form of a colorless and odorless crystalline solid. It is water-soluble and is used, for example, as a food additive.

A mixture of two or of all three organic acids, selected from citric acid, lactic acid and succinic acid, may also be used.

If the disinfectant is present in the form of a solid composition, in particular, as a concentrate, the one or multiple organic acids are present, depending on the particular application, optionally in an amount which is selected from 5-85% by weight, 10-85% by weight, 15-80% by weight, 20-85% by weight, 25-85% by weight, optionally 30-85% by weight.

If the disinfectant is present in the form of an aqueous liquid composition, the one or multiple organic acids are present, depending on the particular application, optionally in an amount selected from 0.1 to 15% by weight or 0.15 to 14% by weight or 0.2 to 13% by weight, optionally 0.5 to 12% by weight.

One further necessary component of the disinfectant provided according to the invention is a benzoate, selected from sodium benzoate, potassium benzoate or calcium benzoate or a mixture thereof.

Benzoic acid is a known aromatic carbonic acid, which is formed from a phenyl residue that includes a carboxyl group. The salts of the benzoic acid are called benzoates. Benzoic acid is a colorless solid with a characteristic odor, which is not readily soluble in water (3.4 g/L at 20° C.). The salts by comparison are readily soluble in water. The salts sodium benzoate (E 211), potassium benzoate (E 212) or calcium benzoate (E 213) are used as preservatives. Due to their preservative properties, the former are used, for example, in the food industry and in cosmetics.

It has been shown that a disinfectant effect of benzoic acid develops, in particular, when the latter stays completely in solution. For this reason, the salts of the benzoic acids that are readily soluble in water are used. As preservatives, they act significantly slower and have therefore not previously appeared as a disinfecting active ingredient in hand disinfectants.

In the disinfectant in the form of a solid composition, the amount of benzoate(s), depending on the particular application, is optionally selected from 1.5-30% by weight, 2.0-29% by weight, 3.0-28% by weight or 4.0-27% by weight, optionally 5.0-26.0% by weight.

In the disinfectant in the form of an aqueous liquid composition, the amount of benzoate(s), depending on the particular application, is optionally selected from 0.1 to 5.0% by weight, 0.15 to 5.0% by weight or 0.2 to 4.5% by weight, optionally 0.25 to 3.5% by weight.

The third necessary component of the disinfectant provided according to the invention is represented by one or multiple surfactants, consisting of one or multiple nonionic surfactants and/or one or multiple amphoteric surfactants, also including a mixture of nonionic and amphoteric surfactants, each of which is soluble or emulsifiable or dispersible in water. According to the invention, one or multiple nonionic surfactants may therefore be present and otherwise no other surfactants. Alternatively, one or multiple amphoteric surfactants may be present and otherwise no other surfactants. A combination of one or multiple nonionic surfactants and one or multiple amphoteric surfactants may also be present and otherwise no other surfactants such as, for example, anionic surfactants or cationic surfactants.

“Nonionic surfactants” are understood to mean surface-active substances, which include no dissociative functional groups and thus form no ions in aqueous solution. The nonionic surfactants possess a polar and a nonpolar molecular part, but no charge and are therefore neutral. The nonionic surfactants used in the present invention are water-soluble. “Water-soluble” is understood here to mean that the nonionic surfactants are soluble in water in such a way that a clear solution is formed. An emulsion may, however, also be formed, in which the nonionic surfactant is present in a stable form emulsified or dispersed in water, i.e., the nonionic surfactant is mixable with water. The solubility of a nonionic surfactant in water may be determined based on the HLB value (Hydrophilic-Lipophilic-Balance). The HLB value indicates the mass ratio between the polar and the nonpolar part in a nonionic surfactant based on the following formula: HLB=20*(M_{hydrophil}/Mₜₒₜₐₗ); M_{hydrophil} being the molar mass of the hydrophilic portion of the nonionic surfactant and M representing the molar mass of the total molecule. The factor 20 is a scaling factor. An HLB value of 1 corresponds to a lipophilic compound, a chemical compound having an HLB value of 20 has a high hydrophilic proportion. The HLB value of the nonionic surfactant used according to the invention is optionally ≥7 and includes not only clear solutions, but also (stable) emulsions. The HLB value of the nonionic surfactant used according to the invention may also be ≥12 or ≥13.

The nonionic surfactants, which are soluble or emulsifiable or dispersible in water, have a high HLB value and thus have the advantage that they ensure a good wetting of hydrophilic surfaces. As a result, an improved disinfectant effect may be expected.

As an alternative to the HLB value, the clouding point of the nonionic surfactant may also be used. Beyond a particular temperature, nonionic surfactants are no longer soluble in water and then form a surfactant-rich phase, which is indicated by a clouding of the solution. This temperature is referred to as the “clouding point” and may therefore be used to characterize water-soluble nonionic surfactants. The higher this clouding point is, the higher the HLB value. The nonionic surfactants used according to the invention therefore optionally have a clouding point in water of 40° C. or greater.

The nonionic surfactants are selected, for example, from fatty alcohol alkoxylates, such as polyalkylene glycol ethers (fatty alcohol ethoxylates), nonylphenol ethoxylates, fatty alcohol propoxylates, fatty amine oxylates, such as fatty amine ethoxylates, fatty acid ethoxylates, fatty acid polyglycol esters, fatty acid polyglycol amides, polyglycerin esters, polyoxyethylene glycolalkyl phenol esters, octylphenol ethoxylates (Octoxinol-9 or Triton X-100), alkanol amides, glycerin alkyl esters or sugar surfactants (glucosides or glycosides; since the designations used in the prior art are not consistent), such as alkyl glucosides, alkyl polyglucosides or alkyl polyglycosides, optionally C₈-C₁₀-alkyl polyglucoside or alkyl polyglycoside, methyl glucoside esters, ethyl glucoside esters, N-methyl glucamide, saccharose esters, in each case alone or mixtures thereof.

Exemplary nonionic surfactants are fatty alcohol alkoxylates and sugar surfactants, such as alkyl polyglucosides or alkyl polyglycosides (APGs), each alone or mixtures thereof.

According to the invention, exemplary fatty alcohol alkoxylates are polyalkyleneglycol ethers, which are also referred to as fatty alcohol polyglycol ethers or fatty alcohol ethoxylates. They are nonionic surfactants, whose lipophilic part consists of fatty alcohols, in particular, alcohols derived from lauric acid, palmitic acid, stearic acid or oleic acid, and whose hydrophilic part is formed from short-chain polyethylene glycols or polyoxyethylenes. Exemplary known commercial names of polyalkylene glycol ethers mentioned are: Brij®, Genapol® and Lutensol®. Polyalkylene glycol ethers as nonionic surfactants are widely used in body care products.

Polyalkylene glycol ethers optionally used are polyoxyethylene ethers of lauric alcohol, such as Laureth-4, Laureth-6, Laureth-9 or Laureth-23; polyoxyethylene ethers of cetyl alcohol, such as Ceteth-10 or Ceteth-20; polyoxyethylene ethers from cetyl stearyl alcohol, such as Ceteareth-20, Ceteareth-25; polyoxyethlene ether of stearyl alcohol, such as Steareth-10 or Steareth-20; or polyoxyethylene ether of oleyl alcohol, such as Oleth-10 or Oleth-20; or C9-11 Pareth 8 (a fatty alcohol ethyloxylate with 8 EO (ethylene oxide units), such as Genapol® UD 88).

Some exemplary polyalkylene glycol ethers are polyoxy ethylene ethers of lauric alcohol, such as Laureth-4 (fatty alcohol ethoxylate with 4EO), Laureth-6 (fatty alcohol ethoxylate with 6EO), Laureth-9 (fatty alcohol ethoxylate with 9EO) or Laureth-23 (fatty alcohol ethoxylate with 23EO) and/or the nonionic surfactants of the Genapol® product series (polyalkylene glycol ether).

Exemplary alkyl polyglucosides or alkyl polyglycosides are C₈-C₁₀-(octyl to decyl-) polyglucoside or polyglycoside as well as coco polyglucoside or coco polyglycoside with a C-chain up to C₁6/C₁₈.

Nonionic surfactants, selected from sugar surfactants, consist of a polar water-soluble molecular part and a non-polar fat-soluble molecular part. They may be ether, ester, amine or amide depending on the chemical bond between the sugar and the alkyl group. The HLB value of a sugar surfactant is a function of the degree of polymerization of the sugar as a polar group and of the number and length of the alkyl chains. Sugar surfactants are environmentally-friendly and generally show a good compatibility with skin. Exemplary sugar surfactants used in the disinfectant provided according to the invention are alkyl glucosides, such as Polysorbate 20 (Tween 20), alkyl polyglucosides or alkyl polyglycosides (APGs), which consistently have an HLB value of >10, such as, for example, Plantacare® (for example, Plantacare® 810 UP: on the following basis: C₈-C₁₀-alkyl polyglucosides or alkyl polyglycosides) or sorbitan esters such as sorbitan monolaurate, which has an HLB value of 8.6. Sugar surfactants are used in the cosmetic industry, for example, as components of shampoos, hair rinses, bath essences or skin cleansers.

Some exemplary sugar surfactants are alkyl glucosides such as polysorbate, alkyl polyglucosides or alkyl polyglycosides (APGs), for example, caprylyl-/capryl glucosides or -glycosides, such as Plantacare©, or sorbitan ester, in particular, sorbitan monolaurate, each alone or mixtures thereof.

It may be advantageous if no polysorbate, in particular, no polysorbate 80, is used as a nonionic surfactant.

According to the invention, some exemplary nonionic surfactants are therefore polyalkylene glycol ethers, selected from the group consisting of poly oxyethylene ethers of lauryl alcohols, such as Laureth-4, Laureth-6, Laureth-9 or Laureth-23, polyoxyethylene ethers of cetyl alcohols, such as Ceteth-10 or Ceteth-20, polyoxyethylene ethers from cetyl stearyl alcohols, such as Ceteraeth-20, Ceteareth-25, polyoxyethylene ethers of stearyl alcohols, such as Steareth-10 or Steareth-20, or polyoxyethylene ethers from oleyl alcohols, such as Oleth-10 or Oleth-20, alkyl polyglucosides or alkyl polyglycosides (APGs), in particular, C₈-C₁₀-alkyl polyglucosides or alkyl polyglycosides, (for example, caprylyl-/capryl glucosides or -glycosides, such as Plantacare® 810 UP: on the following basis: C₈-C₁₀-alkyl polyglucosides or alkyl polyglycosides) or C9-11 Pareth 8 (a polyalkylene glycol ether, in particular a fatty alcohol ethoxylate with 8EO; “Pareth-” refers to a PEG ether of an alkanol (alkyl alcohol); the preceding numbers “C x-y” indicate the length of the alkyl-(carbon) chains; the number following “Pareth” indicates the average number of the —CH₂—CH₂—O— molecular units), such as Genapol® UD 88, or sorbitan ester, such as sorbitan monolaurate, each alone or mixtures thereof.

Some exemplary nonionic surfactants are, in particular, the clear, water-soluble polyoxyethylene ethers of lauryl alcohols, C₉-C₁₁ Pareth-8, alkyl polyglucosides or alkyl polyglycosides, in particular, C5-C10-alkyl polyglucosides or alkyl polyglycosides or sorbitan esters.

The advantage of nonionic surfactants is that they are generally easily tolerated by humans and are not irritating.

For purpose of explanation, it is noted that “glucosides” are actually organic compounds, in which an alcohol is bound to a glucose via a glycosidic bond. “Glycosides” are organic compounds in which an alcohol is bound to a sugar via a glycosidic bond. Thus, glucosides represent a subgroup of glycosides. The terms are however not used in a consistent manner in the prior art since glycosides are frequently also referred to as glucosides. In the present invention, the terms are therefore intended to be used interchangeably, so that a glucoside also encompasses the glycoside and vice versa.

In the disinfectant in the form of a solid composition, the amount of the one or multiple nonionic surfactants, depending on the particular application, is optionally selected from 1.1-30% by weight, 1.5-25% by weight, 2.0-24% by weight, 5-23% by weight or 7.5-22% by weight.

If the disinfectant is present in the form of an aqueous liquid composition, then the one or multiple nonionic surfactants, depending on the particular application, are optionally selected from 1.1-3.0% by weight or 1.1-2.9% by weight or 1.1 to 2.8% by weight or 1.1 to 2.7% by weight or 1.1 to 2.6% by weight or 1.1 to 2.5% by weight or 1.1 to 2.4% by weight or 1.1 to 2.3% by weight or 1.1 to 2.2% by weight or 1.1 to 2.1% by weight or 1.1 to 2.0% by weight or 1.1 to 1.9% by weight or 1.1 to 1.8% by weight or 1.1 to 1.7% by weight or 1.1 to 1.6% by weight or 1.1 to 1.5% by weight, wherein the lower limit in the indicated ranges may also be 1.15% by weight or 1.2% by weight or 1.25% by weight or 1.3% by weight or 1.35% by weight or 1.4% by weight.

Instead of or in addition to the nonionic surfactants, it is also possible to use one or multiple amphoteric surfactants. “Amphoteric” or zwitterionic surfactants are surface-active substances, which contain both a negatively as well as a positively charged functional group. These are polar compounds, which frequently represent solids and are very readily soluble in water. They may be added to nonionic surfactants as co-surfactants or may be used alone. Amphoteric surfactants are used, for example, in dishwashing detergents, shampoos and in other cosmetic products.

According to the invention, the one or multiple amphoteric surfactants are selected from the group consisting of betaines, in particular, alkyl betaines and alkyl amidopropyl betaines, such as cocamidopropyl betaine; sultaines, in particular cocamidopropyl hydroxysultaine; amine oxides, in particular, C₁₂-C₁₄-amine oxides, alkyl amphoacetates and alkyl amphodiacetates. Amino oxides, optionally C₁₂-C₁₄-amino oxides, such as, for example, the commercial product Ammonyx LO, are exemplary.

Some amphoteric surfactants show a charge transfer as a function the pH value. Thus, in the case of an acidic pH value, they exhibit a charge transfer into the positive range. The surfactants then behave similarly to cationic surfactants. In the case of an alkaline pH value, a charge transfer into the negative range takes place, so that the surfactants then behave similarly to anionic surfactants. For the purpose of clarification, it is noted here that anionic surfactants and cationic surfactants, which are, in general, not intended to be present in the disinfectant provided according to the invention, mean those surfactants, which are not amphoteric surfactants, i.e., show no charge transfer when the pH value differs.

Thus, according to some embodiments, only nonionic surfactants and no other surfactants, in particular, no amphoteric, cationic or anionic surfactants, may be included in the disinfectant.

According to some embodiments, nonionic surfactants and/or amine oxide may be included in the disinfectant and no further surfactant, in particular, no further amphoteric surfactant and also no cationic or anionic surfactant.

According to some embodiments, only amine oxide and no further amphoteric surfactant and, in particular, no nonionic, cationic or anionic surfactant, is included in the disinfectant.

In the disinfectant in the form of a solid composition, the amount of the one or multiple amphoteric surfactants, depending on the particular application, is optionally in the range of 1.1-30% by weight, 1.5-25% by weight, 2.0-24% by weight, 5-23% by weight or 7.5-22% by weight.

If the disinfectant is present in the form of an aqueous liquid composition, the amount of the one or multiple amphoteric surfactants, depending on the particular application, is then optionally 1.1-30% by weight, 1.5-25% by weight, 2.0-24% by weight, 5-23% by weight or 7.5-22% by weight.

It has now been found that the combination of the selected organic acid(s)/benzoate(s)/nonionic and/or amphoteric surfactant(s) provides a broad antibacterial spectrum of effects. A high degree of efficacy against gram-positive and gram-negative bacteria is, in particular, observed. Gram-staining is used for the differential staining of bacteria for microscopic examination. The bacteria may be divided into two groups depending on the structure of the cell wall: gram-positive bacteria turn blue in a corresponding stain reaction under the microscope and include, for example, bacterial strains such as Staphylococcus aureus, Pseudomonas aeruginosa, Streptococcus pneumoniae and aerobic spore-formers such as, for example, bacillus. Gram-negative bacteria turn red under the microscope and include, for example, bacterial strains such as Escherichia coli, Helicobacter pylori, Enterobacter gergoviae and Spirillium volutans.

A surprising efficacy of the disinfectant was observed, in particular, against the typical environmental bacteria Escherichia coli, Pseudomonas aeruginosa, Staphylococcus aureus and/or Pluralibacter gergoviae.

Test applications confirm that in addition to the bactericidal and virucidal effect, the disinfectant is also effective against fungi and yeast fungus. A yeast fungus is for example, Candida albicans, known mold fungi are, for example, Aspergillus braseliensis.

The disinfectant composition provided according to the invention is characterized, in particular, by its bactericidal, fungicidal (levuricidal) and virucidal effect.

According to one aspect of the present invention, a synergistic effect of the combination of citric acid, lactic acid and/or succinic acid/benzoate(s)/nonionic and/or amphoteric surfactant(s) is assumed. In a combination of components, a synergistic effect is present if the combination effect is not exhausted in the sum of the individual effects, but rather the overall effect with respect to the disinfection exceeds the effect of the individual components. This may take place and be verified by comparing and contrasting the effects of the components. For example, the effect is considered to be synergistic when the total effect of the three components is superior to the effect that may be achieved with one component alone.

Tests have now shown that the organic acid selected from citric acid, lactic acid and/or succinic acid, together with one or multiple benzoates and one or multiple nonionic and/or amphoteric surfactants, shows a synergistic disinfectant effect. This is all the more surprising, since benzoates (preservatives) and surfactants from a microbiological perspective have a slow activity at pH values <5. The disinfection composition provided according to the invention results in a significantly more rapid disinfectant effect, which is indicated in an extraordinarily rapid contact time. The tests performed prove that a contact time of 30 seconds is already sufficient in order for the disinfectant to be able to have its full disinfectant effect. This represents an unexpectedly fast contact time. At the same time, the germ load is lowered to an extreme degree in this very short contact time, so that bacteria, fungi, yeasts and potentially also viruses present are virtually all killed off. In addition, a long-lasting efficacy is achieved. The methods for determining the quantitative germ loads and contact times for the disinfectant provided according to the invention are described in detail in the tests.

Furthermore, it has proven expedient and advantageous if apart from the nonionic and/or amphoteric surfactants, no further surfactants are present. There are, in particular, no anionic and no cationic surfactants present in the disinfectant provided according to the invention.

Water is used as a solvent for the disinfectant. When the disinfectant is used in the cosmetic field, for example, for disinfecting hands, purified water rendered germ-free is optionally used for the manufacture of the cosmetic product. This may be distilled water or water demineralized by ion exchangers or reverse osmosis and thus germ-free water. Potable water or, for particular applications, also tap water, may be used.

The disinfectant provided according to the invention may—as previously explained—be present in the form of a solution, an emulsion, a spray, a lotion, a gel or foam or in the form of a solid.

For example, the disinfectant provided according to the invention is present as an aqueous, liquid formulation. Alcohol or alcohol mixtures are optionally not used as a solvent in the disinfectant provided according to the invention. Thus, optionally no alcohol, in particular, none of the following solvents: ethanol, methanol, isopropanol or n-propanol, is used in the disinfectant. The disinfectant provided according to the invention includes optionally only water as solvent.

The disinfectant provided according to the invention may also be present as a concentrate in solid form and is only dissolved in water when used. The concentrate is then diluted in water and a suitable dilution is produced for the particular application. Exemplary dilutions are 3.68% to 50% solutions. Other dilutions are equally possible. In general, the dilution is selected in such a way that the disinfectant in the aqueous liquid composition has a nonionic surfactant(s) content in the range of 1.1 to 3.0% by weight and/or an amphoteric surfactant(s) content in the range of 1.1 to 30.0% by weight. The efficacy of the liquid disinfectant is particularly high as a result.

According to some embodiments, the disinfectant provided according to the invention may also contain a ginger-macerate, which may result in a further increase in the disinfection efficiency. Ginger-macerates are water extracts, in particular, cold water extracts, of ginger, in order to dissolve the ingredients thereof. The macerate is used optionally in an amount of 0-2% by weight, particularly optionally 0-0.5% by weight are used in the disinfectant provided according to the invention. The amount depends on the intended application. The ingredients 6-gingeroles and shogaols of the ginger show an antimicrobial efficacy, which has been described, for example, by Ruchi Badoni Semwal, Deepak Kumar Semwal, Sandra Combrinck and Alvaro M. Viljoen in Phytochemistry, vol. 117, September 2015, pp. 554-568.

Instead of a ginger-macerate, the ingredients of ginger could also be added in a suitable amount to the disinfectant in the form of gingerols and shogaols, optionally 6-gingerol.

According to a further aspect of the invention, the disinfectant provided according to the invention may contain common additives known to the person skilled in the art in the present field. Examples thereof, but not limited to these, are: fragrances such as one or multiple etheric oils, optionally selected from the group of lavender oil and/or peppermint oil, and/or one or multiple solubilizers, for example, for solubilizing the etheric oil/oils such as, for example, polyglyceryl-10-laurat. The additives may contribute to a higher efficacy of the disinfectant.

Against the background of the combination of the components organic acid(s)/benzoate(s)/nonionic and/or amphoteric surfactant(s) of the disinfectant, the person skilled in the art may select the additives cited by way of example above with respect to a complete compatibility with the former and add them in corresponding, sufficient amounts as desired. For example, the one or multiple etheric oils are used in an amount of 0-2% by weight, optionally in an amount of 0-0.1% by weight. If one or multiple solubilizers are used, these are then used, for example, in an amount of 0-10% by weight.

One or multiple skin moisture-regulating agents, also referred to as ‘moisturizers’, may further be used. These are, for example, glycols having 2 to 10 carbons, such as butylene glycol, hexylene glycol, caprylyl glycol (1,2 octanediol) (commercial name Dermosoft® Octiol), capric glycol or 1,2 hexanediol (commercial name Hydrolite 6), as well as glycine or glycerin. The one or multiple moisture-regulating agents are used, for example, in the range of 0 to 10% by weight. A exemplary range is 0.1-10% by weight. Glycols having 2 to 10 carbons, such as butylene glycol, hexylene glycol, caprylyl glycol (1,2 octanediol) (commercial name Dermosoft® Octiol), capric glycol or 1,2 hexanediol (commercial name Hydrolite 6) are optionally used. According to some embodiments, the amount of each glycol used in the aqueous composition is present in each case in the range of 0.1 to 2.0% by weight, in particular, in the range of 0.5 to 1.5% by weight. If, for example, hexylene glycol and caprylyl glycol are present as moisture-regulating agents in the aqueous disinfectant, the hexylene glycol may be present in the range of 0.1 to 2.0% by weight, in particular in the range of 0.5 to 1.5% by weight and the caprylyl glycol is also in the range of 0.1 to 2.0% by weight, in particular in the range of 0.5 to 1.5% by weight.

It was found that skin moisture-regulating agents are also clearly able to support the disinfectant effect. It was ascertained, in particular, when fungicide germs such as Candida albicans and Aspergillus brasiliensis are present, that the efficacy of the disinfectant provided according to the invention may be significantly improved by the presence of one or multiple moisture-regulating agents.

According to some embodiments, where one or multiple nonionic surfactants are present, one or multiple moisture-regulating agents are therefore simultaneously present in the disinfectant provided according to the invention. This results in an advantageous increase in the efficacy of the disinfectant.

If only one or multiple amphoteric surfactants are included as surfactants in the disinfectant, the moisture-regulating agent may then also be omitted.

Apart from the active substances organic acid(s), benzoate(s) and nonionic and/or amphoteric surfactant(s), optionally no further active substance is present, but rather only excipients or additives, optionally including or consisting of one or multiple fragrances, one or multiple solubilizers, one or multiple monovalent salts and one or multiple skin moisture-regulating agents.

The disinfectant provided according to the invention, that is present in a solid composition, includes or consists optionally of:
5-85% by weight, 10-85% by weight, 15-85% by weight, 20-85% by weight, 25-85% by weight or 30-85% by weight of organic acid(s);
1.5-30% by weight, 2.0-29% by weight, 3.0-28% by weight, 4.0-27% by weight or 5.0-26.0% by weight of benzoate(s);
1.1-30% by weight, 1.5-25% by weight, 2.0-24% by weight, 5-23% by weight or 7.5-22% by weight of nonionic surfactant(s) and/or 1.1-30% by weight, 1.5-25% by weight, 2.0-24% by weight, 5-23% by weight or 7.5-22% by weight of amphoteric surfactant(s)
0 to 2.0% by weight of ginger-macerate or 6-gingerol;
0.1 to 10.0% by weight of one or multiple moisture-regulating agents;
0 to 2.0% by weight of one or multiple fragrances;
0 to 25.0% by weight of one or multiple monovalent salts, selected in particular from NaCl, KCl and/or LiCl and
0 to 10% by weight of solubilizer.

According to some embodiments, an aqueous disinfectant is provided, including or consisting of:
0.1 to 15% by weight, optionally 0.5 to 12% by weight of organic acid(s);
0.1 to 5.0% by weight, 0.15 to 5.0% by weight or 0.2 to 4.5% by weight, optionally 0.25 to 3.5% by weight of benzoate(s);
1.1-3.0% by weight or 1.1-2.9% by weight or 1.1 to 2.8% by weight or 1.1 to 2.7% by weight or 1.1 to 2.6% by weight or 1.1 to 2.5% by weight or 1.1 to 2.4% by weight or 1.1 to 2.3% by weight or 1.1 to 2.2% by weight or 1.1 to 2.1% by weight or 1.1 to 2.0% by weight or 1.1 to 1.9% by weight or 1.1 to 1.8% by weight or 1.1 to 1.7% by weight or 1.1 to 1.6 or 1.1 to 1.5% by weight, wherein the lower limit in the indicated ranges may also be 1.15% by weight or 1.2% by weight or 1.25% by weight or 1.3% by weight or 1.35% by weight or 1.4% by weight of nonionic surfactant(s) and/or 1.1-30% by weight, 1.5-25% by weight, 2.0-24% by weight, 5-23% by weight or 7.5-22% by weight of amphoteric surfactant(s);
0.1 to 10% by weight of one or multiple moisture-regulating agents, selected in particular, from glycols having 2 to 10 carbons, such as butylene glycol, hexylene glycol, caprylyl glycol, capric glycol, 1,2 hexanediol as well as glycine or glycerin, and mixtures thereof;
0 to 2.0% by weight of one or multiple fragrances, in particular, selected from lavender oil and/or peppermint oil;
0 to 25.0% by weight, optionally 0.5-5% by weight of one or multiple monovalent salts, in particular, selected from NaCl, KCl and/or LiCl;
0 to 10% by weight of solubilizer;
and
67.0 to 98.7% by weight of water.

The amounts of the components in the disinfectant are each of course selected to result in a total of 100% by weight.

The disinfectant provided according to the invention has an acidic pH value in the range of 1.5-4.2, the pH range is particularly optionally 2.0-3.5. Thus, the benzoate is present predominantly as dissolved benzoic acid (pKa 4.2), which represents the real effective component.

Furthermore, the subject matter of the invention is the use of the disinfectant in disinfecting hands, food products, and surfaces, i.e., the disinfectant provided according to the invention is suitable as a hand disinfectant, food product disinfectant and surface disinfectant, wherein a contact time of the disinfectant of 30 seconds in order to show its full disinfectant effect is achieved.

In addition to the traditional public and/or private use of the disinfectant, the latter may also be used in in-situ production sterilization processes. This is the application in manufacturing processes, in which raw materials are used that are required to be sterilized for processing or further processing. This plays a role wherever it is important to be germ-free or that work is intended to be done in a optionally germ-free manner.

The disinfectant is therefore also of particular interest for use in the manufacture of cosmetics, where particular importance is attached to the use of low-germ raw materials. By using the disinfectant provided according to the invention, it is therefore possible, in addition to the existing disinfectant effect of hands and surfaces, to also sterilize problematic contaminated raw materials in the in-situ process. These may be, for example, scrubbing agents or abrasive substances in the form of natural untreated germ meals, such as olive germ meal, apricot germ meal, walnut shell meal, cornmeal and the like. The raw materials may be sterilized directly in the manufacturing process, without having to utilize a complex irradiation process (gamma radiation) or a heating process (at >70° C.) for such purpose. Complex upstream sterilization processes of raw materials may therefore be omitted. The disinfectant provided according to the invention also has the great advantage that a virtually complete sterilization takes place very rapidly, for example, within 30 seconds. This represents economically and ecologically exceptional advantages in the case of an in-situ production sterilization process.

The advantages of the disinfectant provided according to the invention are exceptionally multifaceted:

Thus, components for the disinfectant are used, which are already used as individual components in the food sector or in the cosmetic industry and are therefore toxically harmless. The components are known in part for their skin-friendly properties. They are also notable for their skin and environmental compatibility.

Although no strong oxidants are used, the disinfectant provides a superior bactericidal efficacy, in particular against gram-positive as well as gram-negative bacteria, fungi and also viruses and kills these off to a large extent. This is attributed to a synergistic effect of the three components, organic acid/benzoate/nonionic and/or amphoteric surfactant.

This results in an extraordinarily fast disinfectant effect verified in tests, which is demonstrated in a contact time of not more than 30 seconds. It is particularly surprising that the germicidal rate may be boosted by the use of benzoate(s) and may be increased to an unexpectedly high degree by the addition of nonionic and/or amphoteric surfactant(s). As a result, it is possible to significantly reduce the applied quantity of organic acid(s). At the same time, the germ load is reduced significantly in this very short contact time. Tests confirm that the disinfectant provided according to the invention has a superior effect against Escherichia coli, Pseudomonas aeruginosa, Staphylococcus aureus and/or Pluralibacter gergoviae, wherein the germ load or the germ content is reduced below the detection limit after a contact time of the disinfectant of only 30 seconds. Further tests confirm that the disinfectant provided according to the invention also has a superior effect against fungi, in particular, Candida albicans and/or Aspergillus brasiliensis, the germ load or the germ content being reduced below the detection limit after a contact time of the disinfectant of only 30 seconds. Moreover, a long-lasting efficacy is also observed.

The disinfectant provided according to the invention may be provided in various forms, for example, as a solution, an emulsion, a spray, a lotion, a gel, or a foam or also as a solid water-soluble concentrate. Water is used as the solvent, C₁-C₃-(iso)alcohols are not used as solvents.

According to some embodiments of the invention, the disinfectant may also include a ginger-macerate, which may result in a further increase in the disinfection efficiency.

The disinfectant may be present in an aqueous liquid composition or as a solid composition, in particular, in the form of a concentrate. For the respective application, the concentrate may be diluted with water in order to obtain an aqueous liquid composition.

The optional use of additives, in particular, fragrances, such as essential oil/essential oils, optionally selected from lavender oil and/or peppermint oil, solubilizers or moisture-regulating agents may result in an increase in the efficacy of the disinfectant. The use of moisture-regulating agents, in particular, may show a significant improvement in the efficacy. Using nonionic surfactant(s) and of one or multiple moisture-regulating agents was shown to be advantageous.

In addition to the traditional public and/or private use, the disinfectant may also be used in in-situ production sterilization processes in order to sterilize raw materials prior to processing. This plays an important role, in particular in the cosmetic industry. The raw materials may then be sterilized directly in a preceding step in the manufacturing process without needing to utilize a complex irradiation process (gamma radiation) or a heating process (at >70° C.) for such purpose. In the process, the short contact time of the disinfectant provided according to the invention of 30 seconds has a very advantageous effect. This has exceptional advantages from an economic and ecological perspective.

The disinfectant provided according to the invention may be used repeatedly on a daily basis. For the method of disinfection, it is possible to apply any commonly used method of the EN 1275, the EN 1276/EN1650, but also the application tests EN 1500/1499.

The disinfectant provided according to the invention is accordingly notable for a high bactericidal, fungicidal (levuricidal) and virucidal effect. The disinfectant represents a very fast-acting hand, food and surface disinfectant.

The present invention is explained in greater detail below with reference to tests, without limiting the invention to the latter.

Tests for Sterilization in Cosmetic Formulations

The following equipment was used in the test described below:

Test Equipment:
A BF 720 incubator is used.
A spiral plater is used as a plating device, with which a predefined volume of the suspension to be checked for germs is applied to the culture medium. For example, an Eddy-Jet 2W spiral plater is used.

A manual colony counting device is used for the germ content determinations.

Materials:
Sabouraud agar plates
Caso agar plates
Eddy-Jet disposable syringes
Eddy-Jet sample beakers

The germ count takes place in the screening by the Envirocheck® system for confirmation according to the Ph Eur.6.8. Chapter 2.6.12.

General Procedure:

Subculturing:
The subculturing is carried out by a spiral plater using a corresponding program, depending on the requirements (for example, in one program, higher germ quantities may be more easily broken down by the gradient of the applied product or, in another program, a greater amount may be applied, which drops the lower determination limit).
One (in the case of double samples, two) fungus culture medium and one bacteria culture medium each are taken for each sample.
Standard total germ count checks are performed with no double determination.

Neutralization:
A neutralization, if it is to be carried out, takes place using 50% NaOH.

Incubation:
Bacteria: 2-3 days at 30+/−2° C. in the corresponding incubators;
Yeast/fungus: 3-5 days at room temperature away from light.

Assessment:
Takes place based on the ascertained germ content determinations.

Measurement uncertainty:

The principal uncertainty of the quantitative germ content determination is the amount of applied sample (approximately 5% RSD, relative standard deviation). The evaluation is linear between 10 and 1000 CFU/plate and has a measurement uncertainty (MU) of <0.1 log levels. The total measurement uncertainty is thus approximately 0.15 log-levels.
A count of 100 CFU on one plate corresponds to 1000 CFU/mL and thus maximally between 790 and 1260 CFU/mL.

1. Determination of a Germ Base

In several preliminary tests, a substance was ascertained as a germ base, which is particularly well suitable for investigating a microbial contamination. Particularly suitable for such purpose are scrubbing agents or abrasive substances in the form of natural untreated germ meals, such as olive germ meal, apricot germ meal, walnut shell meal, cornmeal. Walnut shell meal and cornmeal have been shown to be particularly suitable as germ bases, each of which are therefore used in the following tests.

2. Determination of the Initial Microbial Contamination of Walnut Shell Meal and Cornmeal

In tests, the initial microbial contamination of walnut shell meal and cornmeal as a solid or as an aqueous slurry were examined. For germ determination, the test method from the European pharmacopoeia (Pharmacopoea Europaea or Ph.Eur.) 6.8—germ content, Chapter 2.6.12., was used. In the test, 5 samples each of different batches are taken and examined. The results of the germ content determination in untreated walnut shell meal as a solid or as an aqueous slurry of walnut shell meal are summarized in the following Tables 1 and 2:

TABLE 1
Germ content determination of untreated
walnut shell meal as a solid

| Designation | DF | Bacteria | Yeasts | Fungi | TGC |
|---|---|---|---|---|---|
| P268-001 | 1 | 540 | — | n.c. | 540 + n.c |
| P268-002 | 1 | 380 | — | n.c. | 380 + n.c. |
| P268-003 | 1 | 345 | — | n.c. | 345 + n.c. |
| P268-004 | 1 | 500 | — | n.c. | 500 + n.c. |
| P268-005 | 1 | 285 | — | n.c. | 285 + n.c. |

DF . . . dilution factor
n.c. . . . not countable
TGC . . . total germ count
— . . . in the case of yeasts <7 CFU/g or mL

The germ counts correspond to CFU/g or mL (Colony-Forming Units), with respect to the undiluted original product, i.e., depending on the dilution, the dilution factor must be multiplied.

TABLE 2
Germ content determination of an aqueous slurry of
untreated walnut shell meal (dilution factor 1:10)

| Designation | DF | Bacteria | Yeasts | Fungi | TGC |
|---|---|---|---|---|---|
| P268-001 | 10 | 12500 | — | 5000 | 17500 |
| P268-002 | 10 | 16000 | — | 1300 | 17300 |
| P268-003 | 10 | 10000 | — | 1700 | 11700 |
| P268-004 | 10 | 11000 | — | 2100 | 13100 |
| P268-005 | 10 | 8800 | — | 980 | 9780 |

DF . . . dilution factor
TGC . . . total germ count
— . . . in the case of yeasts <7 CFU/g or mL

Additional bacterial growth took place on the culture medium for yeast/fungus.

The results of the germ content determinations of an aqueous slurry of untreated cornmeal are summarized in the following Table 3:

TABLE 3
Germ content determination of an aqueous
slurry of untreated cornmeal

| Designation | DF | Bacteria | Yeasts | Fungi | TGC |
|---|---|---|---|---|---|
| P346-001 | 10 | 7900¹⁾ | — | 3400 | 11300 |
| P346-002 | 10 | 5000²⁾ | — | 4300 | 9300 |
| P346-003 | 10 | 180000³⁾ | — | 3000 | 183000 |
| P346-004 | 10 | 68000 | — | 1800 | 69800 |
| P346-005 | 10 | 20000⁴⁾ | — | 1600 | 21600 |

DF . . . dilution factor
TGC . . . total germ count
— . . . in the case of yeasts <7 CFU/g or mL
¹⁾of which 1500 CFU/mL aerobic spore-formers
²⁾of which 2800 CFU/mL aerobic spore-formers
³⁾of which 8400 CFU/mL aerobic spore-formers
⁴⁾of which 1100 CFU/mL aerobic spore-formers

The values were ascertained from the dilution, since this is also employed in practice.

The microbiological limit values required in the DIN ISO 17516 with respect to the total germ count are fulfilled if they are less than 2000 CFU/g. In exceptional cases for products intended for use by small children or for use close to mucous membranes, the limit value is less than 200 CFU/g.

As is to be expected, the germ status of dry meal as a solid (see Table 1 and 3: without dilution, where DF=1) is very low. Only by adding water (DF=10) is the total germ count increased, which may rise to 10⁶ CFU/g. The acceptable total germ count of 2000 CFU/g according to DIN ISO 17516 is thus far exceeded. A germ reduction is therefore necessary.

3. Sterilization Using Organic Acid

3.1 Sterilization Using Citric Acid

In tests, citric acid was added to a walnut shell meal slurry in water, which exhibits a microbial contamination of up to 10⁶ CFU/g, citric acid was added and adjusted to pH 2.9. 1.6% by weight of citric acid monohydrate was added for this purpose. This amount was maintained at pH 2.9 in the subsequent tests. Following a predefined time span T in minutes, one sample each was collected and incubated for 48 hours in an incubator in order to subsequently determine its germ load. The time span T thus corresponds to the contact time of the disinfectant, in the present case only citric acid.

To ensure that the disinfectant effect in the sample does not continue after collection of the sample and distort the values, the disinfectant effect was stopped by adjusting the sample to a pH value of 7.0 immediately after collection by the addition of 50% sodium hydroxide solution.

The contact time or sample collection was T=5 minutes, T=15 minutes, T=30 min, T=45 minutes or T=60 minutes.

The germ count after incubation takes place using the Environcheck® test sticks immediately or in an outside laboratory. For the external check, the product is cooled and stored for at least 1 day at 8° C. and transferred in a polystyrene box.

The details of the samples taken are indicated in Table 4:

TABLE 4
Walnut shell meal slurry in water with
and without the addition of citric acid

| | | Collected sample/ |
|---|---|---|
| Designation | Addition | contact time T |
| P366-001 | — | 0 minutes |
| P366-002 | citric acid | 15 minutes |
| P366-003 | citric acid | 30 minutes |
| P366-004 | citric acid | 45 minutes |
| P366-005 | citric acid | 60 minutes |

The results of the quantitative germ content determination were as follows:

The germ content determination is based on the Ph. Eur.6.8—germ content, Chapter 2.6.12

TABLE 5
Germ content determination of an aqueous slurry of untreated
walnut cornmeal with and without the addition of citric acid

| Designation | Bacteria | Yeasts | Fungi | TGC |
|---|---|---|---|---|
| P366-001 | 425 | 150 | 75 | 650 |
| P366-002 | 60 | 140 | 50 | 250 |
| P366-003 | 100 | 140 | 55 | 295 |
| P366-004 | 200 | — | 35 | 235 |
| P366-005 | 170 | 35 | 20 | 225 |

TGC . . . Total germ count
— . . . <7 CFU/g or mL

The bacteria here are aerobic spore-formers.

Nutrient agar for bacteria: an additional growth of yeasts and fungi was observed.

Nutrient agar for yeasts and fungi: an additional growth of aerobic spore-formers was observed.

The germ count corresponds to CFU/g or mL (Colony-forming Units), with respect to the original product.

The initial germ count (total germ count TGC) of the aqueous walnut shell meal slurry at T=0 minutes (P366-001) is very low at 650 CFU/g. Nevertheless, it was possible to reduce the germ count to 250 CFU/g by adding citric acid at a pH value of 2.9 after 15 minutes.

This count changed only minimally as a result of a longer acid treatment of the slurry.

3.2 Sterilization Using Lactic Acid

The tests described under 3.1. with and without the addition of citric acid to an aqueous slurry of walnut shell meal were performed in the identical manner as described above, except that lactic acid was used instead of citric acid.

The effect of lactic acid was somewhat stronger, so that a germ load reduction was clearly identifiable after just T=5 minutes.

3.3 Sterilization Using a Different pH Value

The tests using citric acid (tests under section 3.1) and using lactic acid (tests under section 3.2) were each repeated, however, in each case instead of a pH value of 2.9, a pH value of 2.5 or 2.0 or 1.5 was set by adding citric acid or lactic acid in the aqueous walnut shell meal slurry. After a time span of T=5 minutes, T=15 minutes, T=30 minutes, T=45 minutes or T=60 minutes, a sample was collected in order to thus determine the contact time. To ensure that the disinfectant effect of the acid in the sample is completed once the sample is collected and does not continue and thus distort the values, an adjustment was again made using 50% sodium hydroxide solution to a pH value of 7.0. The subsequent incubation of the sample took place over 48 hours.

It was found that lowering the pH value had only a very minimal effect. A germ-free situation is first achieved after 60 minutes. If the incubation period is reduced to 24 hours, a germ-free situation would have been visible after just 30 minutes.

4. Sterilization Using Citric Acid and Sodium Benzoate

4.1 Preliminary Tests

It was to be investigated to what extent the killing rate may be increased by the addition of benzoate, represented by sodium benzoate.

Sodium benzoate is, microbiologically speaking, not an active component, i.e., it is to be expected that as a known preservative, this component possesses only very minimal disinfectant effect. Sodium benzoate dissociates into active benzoic acid (pKa-value of 4.2) upon lowering of a pH value, i.e. at 4.2, sodium benzoate is dissociated up to 50%. While sodium benzoate with 556 g/L at 20° C. is very readily water-soluble, the benzoic acid with 3.4 g/L at 20° C. is only barely water-soluble. Thus, a maximum of only 0.34% of the benzoic acid dissolves in water. Accordingly, when using 0.68% of sodium benzoate at a pH value of 4.2, 0.34% of benzoic acid is present in dissolved, active form. Precipitated benzoic acid is microbiologically no longer active. It is therefore important to determine the solubility product, so that once the pH value is lowered, the benzoic acid is not present in crystalline form.

For this purpose, the solubility product of the active benzoic acid at a pH value of 1, 2, 3, 4 and 5 is ascertained in a preliminary test. To intensify the solubility situation, production-typical, cold water (approximately 10° C.) is used in such case.

It is therefore initially clarified how much sodium benzoate may be dissolved in the neutral range at pH 7 without the benzoic acid precipitating at the previously established lower pH values.

As a variable, the pH value with citric acid is lowered to 1-5 and the solubility in water is checked. After 24 hours, it is checked whether crystals are present in the solution. Citric acid on the other hand is very readily soluble with a pKa of 3.13 in water with 1450 g/L at 20° C. across the entire pH range.

Result: with the preliminary test, it was possible to ascertain that the use of 0.25% by weight of sodium benzoate remains in solution, without difficulty, at a pH value of pH 1. Increasing the pH value also increases the solubility of the benzoic acid-/sodium benzoate balance. The further tests are therefore performed using 0.25% by weight of sodium benzoate.

4.2 Tests Using Citric Acid and Sodium Benzoate

The ascertained amount of sodium benzoate was added to a slurry of walnut shell meal in water, which has a total germ count of up to 10⁶ CFU/g, and dissolved. The pH value was lowered to pH 2.9 using citric acid and one sample each was collected after the time T (T corresponds to the contact time of the citric acid and sodium benzoate on the contaminated walnut shell meal slurry). The sample was then again adjusted to pH 7 using sodium hydroxide solution and incubated in the incubator for 48 hours. The germs in the individual samples were subsequently counted again using the Envirocheck® system internally or using an outside institute by a previously cooled stored product for 1 day.

The contact time T was T=5 minutes, T=15 minutes, T=30 minutes, T=45 minutes, T=60 minutes. The neutralization was carried out using 50% sodium hydroxide solution.

The details of the samples are indicated in Table 6:

TABLE 6
Walnut shell meal slurry in water with and without
the addition of citric acid and sodium benzoate

| | | Collected sample/ |
|---|---|---|
| Designation | Addition | contact time T |
| P375-001 | — | 0 minutes |
| P375-002 | 1.60% by weight of citric acid + | 15 minutes |
| | 0.25% by weight of sodium benzoate | |
| P375-003 | 1.60% by weight of citric acid + | 30 minutes |
| | 0.25% by weight of sodium benzoate | |
| P375-004 | 1.60% by weight of citric acid + | 45 minutes |
| | 0.25% by weight of sodium benzoate | |
| P375-005 | 1.60% by weight of citric acid + | 60 minutes |
| | 0.25% by weight of sodium benzoate | |

The results of the quantitative germ content determination were as follows:

The germ content determination is based on the Ph. Eur.6.8—germ content, Chapter 2.6.12

TABLE 7
Germ content determination of an aqueous slurry
of untreated walnut shell meal with and without
the addition of citric acid and sodium benzoate

| Designation | Bacteria | Yeasts | Fungi | TGC |
|---|---|---|---|---|
| P375-001 | 70 | 415 | 15 | 500 |
| P375-002 | 40 | — | — | 40 |
| P375-003 | 40 | — | — | 40 |
| P375-004 | 50 | — | — | 50 |
| P375-005 | 65 | — | — | 65 |

TGC . . . total germ count
— . . . <7 CFU/g or mL

The bacteria here are aerobic spore-formers.

Nutrient agar for bacteria: an additional growth of yeasts and fungi was observed (only in sample P375-001).

Nutrient agar for yeasts and fungi: an additional growth of aerobic spore-formers was observed.

The germ counts correspond to CFU/g or mL (Colony-forming Units), with respect to the original product.

By using 0.25% by weight of sodium benzoate for the walnut shell meal slurry, which was raised to a pH value of 2.9 using citric acid, it was possible to bring the germ load to a very acceptable value of 40 CFU/g after just 15 minutes.

It is surprising that a preservative such as the benzoic acid in combination with citric acid exhibits a disinfectant effect after such a short period of time.

It was possible to improve upon this result when setting a pH value of 2.3 using the citric acid.

4.3 Tests Using Lactic Acid and Sodium Benzoate

The tests under section 4.2 were repeated, wherein lactic acid is however used instead of citric acid. Lactic acid with a pKa of 3.9 is completely soluble in water and is mixable with water.

The details of the samples are indicated in Table 8:

TABLE 8
Walnut shell meal slurry in water with and without
the addition of lactic acid and sodium benzoate

| | | Collected sample/ |
|---|---|---|
| Designation | Addition | contact time T |
| P487-001 | 2.14% by weight of lactic acid + | 5 minutes |
| | 0.34% by weight of sodium benzoate | |
| P487-002 | 2.14% by weight of lactic acid + | 15 minutes |
| | 0.34% by weight of sodium benzoate | |
| P487-003 | 2.14% by weight of lactic acid + | 30 minutes |
| | 0.34% by weight of sodium benzoate | |
| P487-004 | 2.14% by weight of lactic acid + | 45 minutes |
| | 0.34% by weight of sodium benzoate | |
| P487-005 | 2.14% by weight of lactic acid + | 60 minutes |
| | 0.34% by weight of sodium benzoate | |

The results of the quantitative germ count determination were as follows:

The germ count determination is based on the Ph. Eur. 6.8—Germ content, Chapter 2.6.12

TABLE 9
Germ content determinations of an aqueous slurry
of untreated walnut shell meal with and without
the addition of lactic acid and sodium benzoate

| Designation | Bacteria | Yeasts | Fungi | TGC |
|---|---|---|---|---|
| P487-001 | 55 | — | — | 55 |
| P487-002 | 50 | — | — | 50 |
| P487-003 | 55 | — | — | 55 |
| P487-004 | 85¹⁾ | — | — | 85 |
| P487-005 | 70 | — | — | 70 |

TGC . . . total germ count
— . . . <7 CFU/g or mL
¹⁾of which 50 CFU/mL aerobic spore-formers

The bacteria here are aerobic spore-formers

ulture medium for yeasts and fungi: bacterial growth was observed.

The germ counts correspond to the CFU/g or mL (Colony-forming Units) with respect to the original product.

As may be clearly seen, the germ reduction is clearly visible after just 5 minutes. Only anaerobic spore-formers remained behind which, however, are unavoidable in the system and which do not germinate when the end product is sufficiently preserved.

5. Investigation of the Contact Time Using a Disinfectant Provided According to the Present Invention

The contact time of the disinfectant provided according to the invention was investigated, citric acid being used as the organic acid, sodium benzoate as benzoate and Genapol® UD 88 (C9-11 Pareth 8) (is one of the polyalkylene glycol ethers and is a fatty alcohol ethoxylate with 8EO) as the nonionic surfactant. The amount of sodium benzoate, citric acid and nonionic surfactant was in each case within the range according to the invention. The following methods were used:

Potentiometric determination of the pH value: Ph. Eur. 8.8—pH-Value, Chapter 2.2.3.

Germ content determination: Ph. Eur. 6.8—germ content. Chapter 2.6.12. In deviation thereof, a neutralization or dilution was carried out. A simple determination was made.

The germ load of the aqueous slurry of untreated walnut shell meal was so high that it was unable to be counted. The tests were carried out using this high-grade germ-loaded material.

This means the disinfectant provided according to the invention was added to the slurry and one sample each was collected after the contact time T and its germ load checked as previously explained in detail in the preceding tests.

The tests showed that a contact time of 30 seconds of the disinfectant provided according to the invention is already sufficient to achieve the desired germ reduction.

The neutralization of the sample immediately after the sample collection as a precautionary measure in order to stop the disinfectant effect of the disinfectant and to prevent the distortion of the values, was in fact unnecessary, since the germ reduction with and without NaOH addition was practically identical.

The previous tests showed that the use of citric acid alone does in fact reduce the germ load, but not to a sufficient extent. The addition of sodium benzoate to the citric acid was able to further reduce the germ load in the slurry, however, at least 15 minutes are required in order to provide noteworthy results. By contrast, the combination of citric acid/sodium benzoate/Genapol® UD 88 (C9-11 Pareth 8) according to the invention provided a synergistic increase in the disinfectant effect, a contact time of just 30 seconds being sufficient to lower the germ reduction to a minimum level.

6. Investigation of the Contact Time Using Further Disinfectants Provided According to the Invention
a) The tests under section 5 were repeated, however, instead of the nonionic surfactant Genapol® UD 88 (C9-11 Pareth 8), another nonionic surfactant, namely Plantacare® 810 UP (a C₈C₁₀-alkyl polyglucoside or alkyl polyglycoside), was used.

The same short contact times of the disinfectant of 30 seconds were found, which were already sufficient in order to lower the germ load of the slurry to a minimum in the samples.
b) The tests under section 5 were repeated, however, instead of the nonionic surfactant, an amphoteric surfactant, namely Ammonyx LO (C₁₂-C₁₄-amine oxides), was used.

The same short contact times of the disinfectant of 30 seconds were found, which were already sufficient in order to lower the germ load of the slurry to a minimum in the samples.
c) The tests under section 5 were repeated, however, instead of the nonionic surfactant, a mixture of nonionic and amphoteric surfactant, namely, Plantacare® 810 UP (a C₈C₁₀-alkyl polyglucoside or alkyl polyglycoside) was used as the nonionic surfactant and Ammonyx LO (C₁₂-C₁₄-amine oxides) was used as the amphoteric surfactant. A 1:1 mixture of the surfactants was used.

The same short contact times of the disinfectant of 30 seconds were found, which were already sufficient in order to lower the germ load of the slurry to a minimum in the samples.

7. Determination of the Germ Reduction in In-Situ Processes Using the Disinfectant Provided According to the Invention

Aqueous 3% walnut shell meal slurry having a pH value of 6.7 was used as the medium to be sterilized.

The disinfectant provided according to the invention (1) contained an aqueous solution of citric acid, sodium benzoate and nonionic surfactant in the form of Genapol® UD 88, in each case within the range according to the invention.

The disinfectant provided according to the invention (2) contained an aqueous solution of citric acid, sodium benzoate and nonionic surfactant in the form of Plantacare© 810 UP, in each case within the range according to the invention.

The following methods were used:
Potentiometric determination of the pH value: Ph. Eur. 8.8—pH-Value, Chapter 2.2.3.
Germ content determination: Ph. Eur. 6.8—germ content, Chapter 2.6.12

The procedure was as follows:
1. The germ count was determined from the aqueous walnut shell meal slurry having a pH value of 6.7.
2. The acidification to pH 2.9 using the disinfectant provided according to the invention subsequently took place.
3. The pH value was maintained for 30 seconds and the germ count was then determined.
4. A portion of the slurry was then brought to pH 7 using a 50% NaOH solution and the germ count was again determined.
5. The remaining slurry was subsequently brought to pH 7 using a 50% NaOH solution and the germ count was again determined.

The results were as follows: after only 30 seconds a germ reduction below the detection limit as a result of the use of the disinfectant provided according to the invention took place.

8. Examples 1 Through 8

Determination of the Germ Reduction of Different Compositions of the Disinfectant Provided According to the Invention with Different Individual Germs

The germ reduction for different bacteria was checked in detail using the disinfectant provided according to the invention.

The following bacteria were tested:

TABLE 10
Bacteria used

| Bacteria; | |
|---|---|
| Pseudomonas aeruginosa | DSM 1128 |
| Staphylococcus aureus | DSM 799 |
| Escherichia coli | DSM 787 |
| Pluralibacter gergoviae | DSM 9245 |

The disinfectant provided according to the invention had the compositions as indicated in Table 11:

Test Method:

Disinfection tests in aqueous solution were performed with respect to 4 individual germs (Method: BCL M 04.01.01).

Sample Description and Test Objective:

The examined samples are each acid powder mixtures, which have disinfectant properties in aqueous solution. In the following investigation, this property was checked with respect to four bacterial test germs using short contact times as a basis.

Germ Reduction Test—Test Description

13% aqueous solutions were produced from each of the compositions indicated in Table 11.

The inocula provided were freshly prepared suspensions of the bacteria cited in Table 10. The titer of these solutions was determined by an external dilution series.

One by one, a 10 mL preparation of each of the solutions was inoculated with 100 μl of one of the 4 inoculant suspensions. After 30 seconds, 1 minute, 2 minutes and 5 minutes, respectively, the respective inoculated preparation was neutralized using a 0.1 molar sodium hydroxide solution. These, now neutralized, solutions were plated to 100 μl by a spiral plater on CASO nutrient agar dishes. The dishes were then incubated for a total of 5 days in an incubator at 30° C. and after 2 days, as well as after 5 days, were counted out for the growth of bacteria colonies.

Evaluation:

The following Tables 11-15 show the respective compositions for the disinfectants according to the invention and the results of the germ reduction tests with respect to 4 test germs.

The Plantacare® 810 UP used is a nonionic surfactant on the following basis: C₈-C₁₀-alkyl polyglucosides or alkyl polyglycosides. It is commercially available as a viscous, liquid composition with a water content of 35-38%. The Genapol® UD 88 used is also a nonionic surfactant with the composition: C9-11 Pareth 8. Dermosoft® Octiol is a caprylyl glycol (1,2 octanediol) and represents a moisture-regulator agent. It is solid at room temperature (20-25° C.).

TABLE 11
Compositions provided according to the invention each in the form of a
solid concentrate

| | Disinfectant composition provided according to the invention | | | | | | | |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| | [% by | [% by | [% by | [% by | [% by | [% by | [% by | [% by |
| Component | wt.] | wt.] | wt.] | wt.] | wt.] | wt.] | wt.] | wt.] |
| Sodium | 12.0 | 5.0 | 21.75 | 12.0 | 12.0 | 11.5 | 9.7 | 25.8 |
| benzoate | | | | | | | | |
| Plantacare ® | 17.0 | 10.0 | 21.75 | 8.5 | | | 13.9 | |
| 810 UP | | | | | | | | |
| Genapol ® | | | | 8.5 | 17.0 | 16.4 | | 16.1 |
| UD 88 | | | | | | | | |
| Citric acid | 54.0 | 81.0 | 34.8 | 54.0 | 54.0 | | | |
| monohydrate | | | | | | | | |
| Dermosoft ® | 2.0 | 4.0 | 2.0 | 2.0 | 2.0 | 3.0 | 3.0 | 3.0 |
| Octiol | | | | | | | | |
| Lactic acid | | | | | | 65.5 | 55.6 | 55.1 |
| 98% | | | | | | | | |
| NaCl | 15.0 | | 19.7 | 15.0 | 15.0 | 3.6 | 17.8 | |
| Total | 100 | 100 | 100 | 100 | 100 | 100 | 100 | 100 |

The compositions provided according to the invention, each present as a solid concentrate, were used diluted to a 13% aqueous solution. The compositions for the 13% aqueous solution are indicated in the following Table 12:

TABLE 12
Compositions provided according to the invention of the concentrates of Table 11,
each in a 13% aqueous solution

| | Disinfectant composition provided according to the invention | | | | | | | |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| | [% by | [% by | [% by | [% by | [% by | [% by | [% by | [% by |
| Component | wt.] | wt.] | wt.] | wt.] | wt.] | wt.] | wt.] | wt.] |
| Sodium | 1.56 | 0.65 | 2.83 | 1.56 | 1.56 | 1.50 | 1.26 | 3.35 |
| benzoate | | | | | | | | |
| Plantacare ® | 2.21 | 1.30 | 2.83 | 1.11 | | | 1.81 | |
| 810 UP | | | | | | | | |
| Genapol ® | | | | 1.11 | 2.21 | 2.13 | | 2.09 |
| UD 88 | | | | | | | | |
| Citric acid | 7.02 | 10.53 | 4.52 | 7.02 | 7.02 | | | |
| monohydrate | | | | | | | | |
| Dermosoft ® | 0.26 | 0.52 | 0.26 | 0.26 | 0.26 | 0.39 | 0.39 | 0.390 |
| Octiol | | | | | | | | |
| Lactic acid | | | | | | 8.52 | 7.23 | 7.16 |
| 98% | | | | | | | | |
| NaCl | 1.95 | | 2.56 | 1.95 | 1.95 | 0.47 | 2.31 | |
| Total | 13.00 | 13.00 | 13.00 | 13.01 | 13.00 | 13.01 | 13.00 | 12.99 |
| Water | 87.00 | 87.00 | 87.00 | 86.99 | 87.00 | 86.99 | 87.00 | 87.01 |
| content in | | | | | | | | |
| 13% | | | | | | | | |
| solution | | | | | | | | |

TABLE 13
Compositions provided according to the invention and their germ reduction after 30
seconds, 60 second and 2 minutes

| | Disinfectant composition provided according to the invention | | | | | | | |
|---|---|---|---|---|---|---|---|---|
| Component | Ex. 1 | Ex. 2 | Ex. 3 | Ex. 4 | Ex. 5 | Ex. 6 | Ex. 7 | Ex. 8 |
| Bacteria: | Germ content (CFU/mL] after 30 seconds | | | | | | | |
| St. aureus | <13 | <13 | <13 | <13 | <13 | <13 | <13 | <13 |
| Ps. | <13 | <13 | <13 | <13 | <13 | <13 | <13 | <13 |
| aeruginosa | | | | | | | | |
| E. coli | <13 | <13 | <13 | <13 | <13 | <13 | <13 | <13 |
| Pl. | <13 | <13 | <13 | <13 | <13 | <13 | <13 | <13 |
| gergoviae | | | | | | | | |
| Bacteria: | Germ content (CFU/mL] after 60 seconds | | | | | | | |
| St. aureus | <13 | <13 | <13 | <13 | <13 | <13 | <13 | <13 |
| Ps. | <13 | <13 | <13 | <13 | <13 | <13 | <13 | <13 |
| aeruginosa | | | | | | | | |
| E. coli | <13 | <13 | <13 | <13 | <13 | <13 | <13 | <13 |
| Pl. | <13 | <13 | <13 | <13 | <13 | <13 | <13 | <13 |
| gergoviae | | | | | | | | |
| Bacteria: | Germ content (CFU/mL] after 2 minutes | | | | | | | |
| St. aureus | <13 | 13 | <13 | <13 | <13 | <13 | <13 | <13 |
| Ps. | <13 | <13 | <13 | <13 | <13 | <13 | <13 | <13 |
| aeruginosa | | | | | | | | |
| E. coli | <13 | <13 | <13 | <13 | <13 | <13 | <13 | <13 |
| Pl. | <13 | <13 | <13 | <13 | <13 | <13 | <13 | <13 |
| gergoviae | | | | | | | | |

TABLE 14
Compositions provided according to the invention and their germ reduction after 5
minutes

| | Disinfectant composition provided according to the invention | | | | | | | |
|---|---|---|---|---|---|---|---|---|
| Component | Ex. 1 | Ex. 2 | Ex. 3 | Ex. 4 | Ex. 5 | Ex. 6 | Ex. 7 | Ex. 8 |
| Bacteria: | Germ content (CFU/mL] after 5 minutes | | | | | | | |
| St. aureus | <13 | <13 | <13 | <13 | <13 | <13 | <13 | <13 |
| Ps. | <13 | <13 | <13 | <13 | <13 | <13 | <13 | <13 |
| aeruginosa | | | | | | | | |
| E. coli | <13 | <13 | <13 | <13 | <13 | <13 | <13 | <13 |
| Pl. | <13 | <13 | <13 | <13 | <13 | <13 | <13 | <13 |
| gergoviae | | | | | | | | |

The germ content measurements for the composition A were, in particular, as follows:

TABLE 15
Germ content measurements for the composition of Example 1

| | Inoculation | Germ content [CFU/mL] after | | | |
|---|---|---|---|---|---|
| | Germ count | 30 | 60 | 2 | 5 |
| Germ | [CFU/mL] | seconds | seconds | minutes | minutes |
| St. aureus | 9.5E6 | <13 | <13 | <13 | <13 |
| Ps. aeruginosa | 5.5E6 | <13 | <13 | <13 | <13 |
| E. coli | 4.0E6 | <13 | <13 | <13 | <13 |
| Pl. gergoviae | 1.5E6 | <13 | <13 | <13 | <13 |

At the start of the different tests, the inoculation germ count for the compositions of the Examples 2 through 8 was in each case of a corresponding size.

Result:

The germ reduction tests on the disinfectants of the Examples 1 through 8 used according to the invention showed a surprisingly high germ reduction effect in 13% aqueous solution in each case with respect to the bacterial test germs Escherichia coli, Pseudomonas aeruginosa, Staphylococcus aureus and Pluralibacter gergoviae. These germs were able to be reduced, in each case from initially over 1E6 colony-forming units (CFU)/mL to <13 CFU/mL after just 30 seconds of contact time. In other words, the disinfectant provided according to the invention reached its full efficacy after a contact time of just 30 seconds and reduced the germ load in the case of typical germs to a minimum.

9. Examples 9 Through 22

Determination of the Germ Reduction Based on Further Compositions of the Disinfectant Provided According to the Invention

Based on several aqueous liquid compositions for the disinfectant provided according to the invention, the germ reduction was again checked in detail. The compositions and results are combined in particular in the following tables:

The Plantacare® 810 UP used is a nonionic surfactant commercially available in the form of an aqueous solution on the following basis: C₈-C₁₀-alkyl polyglucoside or alkyl polyglycoside. Ammonyx LO is an amphoteric surfactant in the form of C12-C14 amine oxides. Dermosoft® Octiol is a caprylyl glycol and represents a moisture-regulating agent. Hydrolite 6 is a 1,2 hexanediol and represents a moisture-regulating agent. Glycerin is a moisture-regulating agent.

TABLE 16A
Compositions provided according to the invention and their germ reduction

| | Example | Example | Example | Example | Example | Example | Example |
|---|---|---|---|---|---|---|---|
| | 9 | 10 | 11 | 12 | 13 | 14 | 15 |
| | [% by | [% by | [% by | [% by | [% by | [% by | [% by |
| Component | wt.] | wt.] | wt.] | wt.] | wt.] | wt.] | wt.] |
| Demineralized | 92.90 | 91.00 | 90.00 | 95.30 | 91.30 | 91.05 | 90.85 |
| water | | | | | | | |
| Citric acid | 0.80 | 1.00 | 1.00 | 1.30 | 1.30 | 1.60 | 1.90 |
| mono | | | | | | | |
| Plantacare ® | 1.8 | 2.00 | 3.00 | 2.00 | 3.00 | 2.00 | 3.00 |
| 810 UP | | | | | | | |
| Sodium | 0.50 | 0.50 | 0.50 | 0.40 | 0.40 | 0.35 | 0.25 |
| benzoate | | | | | | | |
| Glycerin | 2.00 | 4.00 | 4.00 | | 2.00 | 4.00 | 4.00 |
| Hydrolite 6 | 1.00 | 1.00 | 1.00 | 0.50 | 1.00 | 1.00 | |
| Dermosoft ® | 1.00 | 0.50 | 0.50 | 0.50 | 1.00 | | |
| Octiol | | | | | | | |
| Ammonyx | | | | | | | |
| LO | | | | | | | |
| pH Value | 3.5 | 3.5 | 3.5 | 3 | 3 | 2.5 | 2 |
| EN 1275 | + | + | + | + | + | + | + |
| EN 1650 | + | + | + | + | + | + | + |

+ reduction of the germ count within 30 seconds below the detection limit

TABLE 16B
Compositions provided according to the invention and their germ reduction

| | Example | Example | Example | Example | Example | Example | Example |
|---|---|---|---|---|---|---|---|
| | 16 | 17 | 18 | 19 | 20 | 21 | 22 |
| | [% by | [% by | [% by | [% by | [% by | [% by | [% by |
| Component | wt.] | wt.] | wt.] | wt.] | wt.] | wt.] | wt.] |
| Demineralized | 83.10 | 88.00 | 85.00 | 82.50 | 83.10 | 89.50 | 88.00 |
| water | | | | | | | |
| Citric acid | 5.50 | 5.50 | 4.50 | 4.00 | 5.50 | 4.00 | 4.00 |
| mono | | | | | | | |
| Plantacare | | | | | | | |
| 810 UP | | | | | | | |
| Sodium | 0.40 | 0.50 | 0.50 | 0.50 | 0.40 | 0.50 | 0.50 |
| benzoate | | | | | | | |
| Glycerin | 3.00 | 2.00 | 2.00 | 3.00 | 3.00 | 2.00 | 4.00 |
| Hydrolite 6 | | | | | 1.00 | 1.00 | 1.00 |
| Dermosoft | | | | | 1.00 | 1.00 | 0.50 |
| Octiol | | | | | | | |
| Ammonyx | 8.00 | 4.00 | 8.00 | 10.00 | 6.00 | 2.00 | 2.00 |
| LO | | | | | | | |
| pH-Value | 2.5 | 2.5 | 3 | 3.5 | 2.50 | 3.50 | 3.50 |
| EN 1275 | + | + | + | + | + | + | + |
| EN 1650 | + | + | + | + | + | + | + |

+ reduction of the germ count within 30 seconds below the detection limit

Result:

The germ reduction tests on the disinfectants of the Examples 9 through 22 used according to the invention showed a surprisingly high germ reduction effect in each case with respect to the bacterial test germs Escherichia coli, Pseudomonas aeruginosa, Staphylococcus aureus and Pluralibacter gergoviae. These germs were able to be reduced, in each case from initially over 1E6 colony-forming units (CFU)/mL to below the detection limit after just 30 seconds of contact time. The disinfectant provided according to the invention reached its full efficacy after a contact time of just 30 seconds and reduced the germ load in the case of typical germs to a minimum.

In particular, the presence of one or multiple moisture-regulating agents is particularly advantageous, since these further intensify the antibacterial and, in particular, fungicidal efficacy of the disinfectant.

10. Variation of the Amount of Sodium Benzoate in the Disinfectant Provided According to the Present Invention

Tests revealed that a variation in the amount of sodium benzoate in the entire range according to the invention of 0.01-30.0% by weight, in particular, 0.25-30.0% by weight, resulted in the desired short contact time and germ reduction, since the increase to a maximum presence of the active benzoic acid until saturation in the solution is provided.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A disinfectant, comprising:
an organic acid selected from the group consisting of citric acid, lactic acid, succinic acid, and mixtures thereof;
a benzoate selected from the group consisting of sodium benzoate, potassium benzoate, calcium benzoate, and mixtures thereof; and
one or more surfactants selected from the group consisting of nonionic surfactants and amphoteric surfactants which are soluble or emulsifiable or dispersible in water;
the disinfectant being present in aqueous liquid composition or solid composition; wherein an aqueous liquid composition of the disinfectant contains the one or more nonionic surfactants in an amount ranging from 1.1 to 3% by weight and/or containing the one or more amphoteric surfactants in an amount ranging from 1.1 to 30% by weight;
the solid composition being a concentrate and the aqueous liquid composition being the concentrate in diluted form containing the one or more nonionic surfactants in an amount ranging from 1.1 to 3% by weight and/or the one or more amphoteric surfactants in an amount ranging from 1.1 to 30% by weight;
the disinfectant being intended for external use only;
wherein the one or more nonionic surfactants are selected from the group consisting of fatty alcohol alkoxylates, alkyl polyglucosides alkyl polyglycosides (APGs), and mixtures thereof;
wherein the one or more amphoteric surfactants are selected from the group consisting of amine oxides and when, with one or more nonionic surfactants present, one or more moisture control agents are simultaneously present, the moisture control agents being present in an amount ranging from 0.1 to 5% by weight;
wherein no surfactants other than the nonionic and/or amphoteric surfactants are present, no C₁-C₃ (iso) alcohols are present, with C₁-C₃ (iso) alcohols being methanol, ethanol, n-propanol and isopropanol, and the compounds chlorhexidine digluconate, sorbitan caprylate, and phenoxyethanol are not present.

2. The disinfectant of claim 1, wherein the one or more nonionic surfactants are selected from the group consisting of polyoxyethylene ethers of lauryl alcohols, C₉-C₁₁ pareth-8, C₈-C₁₀ alkyl polyglycosides, glucosides, and mixtures thereof.

3. The disinfectant of claim 1, wherein the one or more nonionic surfactants have a Hydrophilic-Lipophilic-Balance value of ≥7 or have a clouding point of 40° C. or greater with a content of 1 g in 100 ml water.

4. The disinfectant of claim 1, wherein the one or more amphoteric surfactants are selected from the group consisting of C₁₂-C₁₄ amine oxides.

5. The disinfectant of claim 1, wherein the disinfectant is present in the form of at least one of an aqueous liquid composition, a solution, an emulsion, a lotion, a spray, a gel, a foam, or a solid composition in the form of a concentrate that is water soluble or emulsifiable or dispersible in water.

6. The disinfectant of claim 1, wherein the disinfectant is in the form of a solid composition and the one or more organic acids are present in an amount selected from 5-85% by weight or the disinfectant is in the form of an aqueous liquid composition and the one or more organic acids are present in an amount selected from 0.1-15% by weight.

7. The disinfectant of claim 1, the disinfectant is in the form of a solid composition and the one or more benzoates are present in an amount selected from 1.5-30% by weight or the disinfectant is in the form of an aqueous liquid composition and the one or more benzoates are present in an amount selected from 0.1 to 5.0% by weight.

8. The disinfectant of claim 1, wherein the disinfectant is in the form of a solid composition and the one or more nonionic surfactants are present in an amount selected from 1.1-30% by weight; or the disinfectant is in the form of an aqueous liquid composition and the one or more nonionic surfactants are present in an amount selected from 1.1-3.0%.

9. The disinfectant of claim 1, wherein the disinfectant is in the form of a solid composition and the one or more amphoteric surfactants are present in an amount selected from 1.1-30% by weight; or
the disinfectant is in the form of an aqueous liquid composition and the one or more amphoteric surfactants are present in an amount selected from 1.1-30% by weight.

10. The disinfectant of claim 1, wherein the one or more moisture control agents are selected from the group consisting of glycols having 2 to 10 carbons, butylene glycol, hexylene glycol, caprylyl glycol, capric glycol, and 1,2-hexanediol, glycine, glycerine, and mixtures thereof

11. The disinfectant of claim 1, further comprising at least one of the following:
one or more additives selected from a ginger macerate or 6-gingerol;
one or more aromatic substances;
one or more solubilizing agents;
one or more monovalent salts; or
KCl, NaCl, and/or LiCl.

12. The disinfectant of claim 1, wherein the disinfectant is a solid composition comprising or consisting of:
5-85% by weight one or more organic acids;
1.5-30% by weight one or more benzoates;
1.1-30% by weight one or more nonionic surfactants and/or 1.1-30% by weight one or more amphoteric surfactants
0 to 2.0% by weight ginger macerate or 6-gingerol;
0.1 to 5.0% by weight one or more moisture control agents;
0 to 2.0% by weight one or more aromatic substances;
0 to 25.0% by weight one or more monovalent salts selected from NaCl, KCl and/or LiCl; and
0 to 10% by weight solubilizing agent;
or
the disinfectant is present as an aqueous liquid composition comprising or consisting of:
0.1 to 15% by weight one or more organic acids;
0.1 to 5.0% by weight one or more benzoates;
1.1-3.0% by weight one or more nonionic surfactants and/or 1.1-30% by weight one or more amphoteric surfactants;
0.1% to 5.0% by weight one or more moisture control agents;
0 to 2.0% by weight one or more aromatic substances;
0 to 25.0% by weight one or more monovalent salts selected from NaCl, KCl, and/or LiCl;
0 to 10% by weight solubilizing agent;
and
67.0 to 98.7% by weight water.

13. A method of using a disinfectant, the method comprising:
disinfecting a surface by contacting the surface with the disinfectant for a contact time, the disinfectant comprising:
an organic acid selected from the group consisting of citric acid, lactic acid, succinic acid, and mixtures thereof;
a benzoate selected from the group consisting of sodium benzoate, potassium benzoate, calcium benzoate, and mixtures thereof; and
one or more surfactants selected from the group consisting of nonionic surfactants and amphoteric surfactants which are soluble or emulsifiable or dispersible in water;
the disinfectant being present in aqueous liquid composition or solid composition; wherein an aqueous liquid composition of the disinfectant contains the one or more nonionic surfactants in an amount ranging from 1.1 to 3% by weight and/or containing the one or more amphoteric surfactants in an amount ranging from 1.1 to 30% by weight;
the solid composition being a concentrate and the aqueous liquid composition being the concentrate in diluted form containing the one or more nonionic surfactants in an amount ranging from 1.1 to 3% by weight and/or the one or more amphoteric surfactants in an amount ranging from 1.1 to 30% by weight;
the disinfectant being intended for external use only;
wherein the one or more nonionic surfactants are selected from the group consisting of fatty alcohol alkoxylates, alkyl polyglucosides alkyl polyglycosides (APGs), and mixtures thereof;
wherein the one or more amphoteric surfactants are selected from the group consisting of amine oxides and when, with one or more nonionic surfactants present, one or more moisture control agents are simultaneously present, the moisture control agents being present in an amount ranging from 0.1 to 5% by weight;
wherein no surfactants other than the nonionic and/or amphoteric surfactants are present, no C₁-C₃ (iso) alcohols are present, with C₁-C₃ (iso) alcohols being methanol, ethanol, n-propanol and isopropanol, and the compounds chlorhexidine digluconate, sorbitan caprylate, and phenoxyethanol are not present;
wherein a contact time of the disinfectant with the surface of 30 seconds is sufficient to exhibit its complete disinfecting effect.

14. The method of claim 13, wherein the contacting reduces a germ load of at least one of Escherichia coli, Pseudomonas aeruginosa, Staphylococcus aureus, Pluralibacter gergoviae, or Candida albicans on the surface below a detection limit after the contact time with the disinfectant of 30 seconds.
